(19) United States
(12) Patent Application Publication
(10) Pub. No.: US 2025/0286225 A1
(43) Pub. Date: Sep. 11, 2025

(54) ENERGY STORAGE CELL HAVING A WOUND ELECTRODE-SEPARATOR ASSEMBLY AND METHOD FOR PRODUCING SAME

(71) Applicant: VARTA Microbattery GmbH, Ellwangen Jagst (DE)

(72) Inventors: Edward Pytlik, Ellwangen (DE); Martin Fürst, Rainau-Schwabsberg (DE); David Ensling, Ellwangen (DE); Bernd Beck, Munningen (DE)

(21) Appl. No.: 18/858,372

(22) PCT Filed: Apr. 17, 2023
(86) PCT No.: PCT/EP2023/059925

§ 371 Date: Oct. 21, 2024

(30) Foreign Application Priority Data
Apr. 22, 2022 (EP) 22169551.3

(51) Int. Cl. H01M 50/463; H01M 4/75; H01M 10/0587; H01M 50/403; H01M 50/437; H01M 50/531

(52) U.S. Cl. CPC H01M 50/463; H01M 4/75; H01M 10/0587; H01M 50/403; H01M 50/437; H01M 50/531

(57) ABSTRACT

An energy storage cell includes an electrode-separator assembly designed as a cylindrical winding with two terminal end faces. The electrode-separator assembly includes at least one ribbon-shaped positive electrode including a ribbon-shaped cathode current collector with a coating of positive electrode material, at least one ribbon-shaped negative electrode including a ribbon-shaped anode current collector with a coating of a negative electrode material, and at least one separator including at least one separator ribbon arranged between at least one positive electrode and at least one negative electrode so as to separate the electrodes from each other. The separator ribbon includes a first and a second side, each facing one of the electrodes, and a first longitudinal edge and a second longitudinal edge. The separator ribbon has a coating including an inorganic non-conductor on the first side and/or the second side, at least in an area. A longitudinal edge of the separator ribbon is rolled in at least a section.

### CROSS REFERENCE TO RELATED APPLICATIONS

This application is a U.S. National Phase application under 35 U.S.C. § 371 of International Application No. PCT/EP2023/059925, filed on Apr. 17, 2023, and claims benefit to European Patent Application No. EP 22169551.3, filed on Apr. 22, 2022. The International Application was published in German on Oct. 26, 2023 as WO/2023/202987 under PCT Article 21(2).

### FIELD

The present disclosure relates to an energy storage cell with an electrode-separator assembly in the form of a cylindrical winding and a method of manufacturing the same.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as these cells can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material or the corresponding electrode material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly during the production of a lithium-ion cell. The electrodes and separators are often, but not necessarily, joined together under pressure, possibly by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in tools, lithium-ion cells with the highest possible energy density are required, which are also able to withstand high currents during charging and discharging.

Cells for the applications mentioned are often designed as cylindrical round cells, for example with a form factor of 21×70 (diameter*height in mm). Cells of this type generally comprise an electrode-separator assembly in the form of a winding. Modern lithium-ion cells of this form factor can already achieve an energy density of up to 270 Wh/kg.

WO 2017/215900 A1 describes cylindrical round cells in which the electrode-separator assembly and its electrodes are ribbon-shaped and in the form of a winding. The electrodes each have ribbon-shaped electrodes loaded or coated with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on an opposite side. For electrical contacting of the current collectors, the cells have sheet metal parts that sit flat on the end faces of the winding and are assembled by welding to the longitudinal edges of the current collectors. This makes it possible to electrically contact the current collectors and thus also the associated electrodes over their entire length. Cells with windings contacted in this way have a significantly reduced internal resistance. As a result, the occurrence of large currents can be absorbed much better and heat can also be dissipated better from the winding.

During the production of such cells as well as during the operation of such cells, especially during charging and discharging, various particles, especially electrically conductive particles, can penetrate the winding-shaped electrode-separator assembly. The end faces of the winding are a particularly critical region here, as there are some open areas. For example, soot particles or graphite or carbon black can be washed out of the electrodes and deposited in the spaces between the electrodes. Furthermore, particles, for example metallic particles, can penetrate the electrode-separator assembly during the production and assembly of the cells.

These particles can cause the electrode polarities to be bridged, which can lead to fine short circuits. In extreme cases, this can lead to a short circuit, which can cause the cell to fail. Overall, this penetration of various particles into the electrode-separator assembly poses a not inconsiderable safety risk for the cells.

### SUMMARY

In an embodiment, the present disclosure provides an energy storage cell. The energy storage cell includes an electrode-separator assembly designed as a cylindrical winding with two terminal end faces. The electrode-separator assembly includes at least one ribbon-shaped positive electrode including a ribbon-shaped cathode current collector with a coating of positive electrode material, at least one ribbon-shaped negative electrode including a ribbon-shaped anode current collector with a coating of a negative electrode material, and at least one separator including at least one separator ribbon arranged between at least one positive electrode and at least one negative electrode so as to separate the electrodes from each other. The separator ribbon includes a first and a second side, each facing one of the electrodes, and a first longitudinal edge and a second longitudinal edge. The separator ribbon has a coating including an inorganic non-conductor on the first side and/or the second side, at least in an area. The first longitudinal edge and/or the second longitudinal edge of the separator ribbon is rolled in at least a section.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a schematic representation of a longitudinal section through a lithium-ion energy storage cell; and

FIG. 2 provides an X-ray representation of a section of the end face region of a winding-shaped electrode-separator assembly.

### DETAILED DESCRIPTION

The present disclosure provides an improved energy storage cell which avoids or at least minimizes this safety risk due to particles penetrating the electrode-separator assembly. Furthermore, the present disclosure provides a method of manufacturing such an improved energy storage cell which is very easy to implement in practice.

According to a first aspect, an energy storage cell is characterized by the following features:
a. The energy storage cell comprises an electrode-separator assembly of at least one positive electrode, at least one negative electrode and at least one separator;
b. The positive electrode is ribbon-shaped and comprises a ribbon-shaped cathode current collector with a coating of a positive electrode material;
c. The negative electrode is ribbon-shaped and comprises a ribbon-shaped anode current collector with a coating of a negative electrode material;
d. The electrode-separator assembly is designed as a cylindrical winding with two terminal end faces and comprises the electrodes in a spirally wound form;
e. The at least one separator comprises at least one separator ribbon arranged between the positive and negative electrodes and separating the electrodes from each other; and
f. the at least one separator ribbon has a first and a second flat side, each facing one of the electrodes, as well as a first longitudinal edge and a second longitudinal edge.

In accordance with the an embodiment, the energy storage cell is characterized by the following additional features:
g. The separator ribbon has a coating of an inorganic non-conductor on one of its flat sides, at least in an area; and
h. at least one of the longitudinal edges of the separator ribbon is rolled in at least a section.

The basic structure of the winding-shaped electrode-separator assembly of this energy storage cell is comparable to the structure of an electrode-separator assembly of a conventional cell, as described, for example, in WO 2017/215900 A1. The significant difference between this cell and such a conventional cell is that the end faces or at least one of the end faces of the winding-shaped electrode-separator assembly are modified in such a way that the longitudinal edge or edges of the separator ribbon or ribbons, which are located on one or both end faces of the cylindrical winding, are deformed and, in particular, at least partially rolled. This achieves partial or complete closure of the end faces of the winding, so that penetration of particles into the interior of the electrode-separator assembly is minimized or completely prevented. This reliably prevents fine and/or short circuits caused by electrically conductive particles that could penetrate into the electrode-separator assembly. In this respect, the safety level of the cells is significantly elevated by the measure.

As will be explained in more detail in connection with the preferred manufacturing process for the energy storage cells described below, this rolling of the longitudinal edges of the separator ribbon or ribbons is achieved in particular by a thermal treatment, whereby the separator ribbon or ribbons are at least partially provided with a coating of an inorganic non-conductor. This may be a ceramic coating, for example. It is preferable if this ceramic coating is located at least in the region of the longitudinal edges of the separator ribbons on only one of the flat sides of the respective separator ribbon. During thermal treatment, this one-sided coating causes the longitudinal edge of the separator ribbon to roll in a predictable and defined manner, resulting in a regularly formed structure in the end face regions of the winding, which causes the winding end face(s) to close. The measure thus achieves a targeted and controlled, complete or partial closure of the winding.

Preferably, the at least one of the longitudinal edges of the separator ribbon is rolled in such a way that it comprises at least one complete winding, preferably two or more windings. Preferably, it comprises a region in which the separator ribbon is present in at least two layers as a result of being rolled.

The coating with an inorganic non-conductor and the rolling of the longitudinal edge(s) of the separator ribbon(s) also has an electrically insulating function in addition to the primarily mechanical function of sealing the end face(s) of the winding. Furthermore, the coating and the rolling of the longitudinal edges can also have a mechanically stabilizing function for the electrode-separator assembly.

The energy storage cell is preferably a lithium-ion cell.

For the electrodes of a lithium-ion cell, basically all electrode materials known for secondary lithium-ion cells can be used.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity for the receptability of lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also particularly suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of the aforementioned materials can also be used. The cathodic active materials are also preferably used in particulate form.

Alternatively, the energy storage cell can also be a sodium-ion cell, a potassium-ion cell, a calcium-ion cell, a magnesium-ion cell or an aluminum-ion cell. Among these variants, energy storage cells with sodium-ion cell chemistry are preferred.

The negative electrode material of an energy storage element based on sodium ions is, for example, one of the following materials:
carbon, especially hard carbon (pure or with nitrogen and/or phosphorus doping) or soft carbon or graphene-based materials, carbon nanotubes, graphite
phosphorus or sulphur
polyanions such as Na₂Ti₃O₇, Na₃Ti₂(PO₄)₃, TiP₂O₇, TiNb₂O₇, Na—Ti—(PO₄)₃, Na—V—(PO₄)₃
Transition metal oxides such as V₂O₅, MnO₂, TiO₂, Nb₂O₅, Fe₂O₃, Na₂Ti₃O₇, NaCrTiO₄, Na₄Ti₅O₁₂

Alternatively, a Na metal anode can also be used on the anode side.

The positive electrode material of an energy storage element based on sodium ions is, for example, one of the following materials:
polyanions: NaFePO₄ (triphylite type), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, NaCoPO₄, Na₂CoPO₄F
silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

Regardless of whether the electrodes are based on sodium-ion cell chemistry or lithium-ion cell chemistry, they preferably contain an electrode binder and/or an additive to improve the electrical conductivity. The active materials are preferably embedded in a matrix of the electrode binder, with neighboring particles in the matrix preferably being in direct contact with each other. Conductive agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

The energy storage cell preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

In the case of a sodium ion cell, it preferably comprises an electrolyte comprising at least one of the following solvents and at least one of the following conducting salts:
Organic carbonates, ethers, nitriles and mixtures thereof are particularly suitable as solvents.
Preferred conducting salts are NaPF6, sodium difluoro(oxalato)borate (NaBOB), NaBF₄, sodium bis(fluorosulfonyl)imide (NaFSI), sodium 2-trifluoromethyl-4,5-dicyanoimidazole (NaTDI), sodium bis(trifluoromethanesulfonyl)imide (NaTFSI), NaAsF₆, NaBF₄, NaClO₄, NaB(C₂O₄)₂, NaP(C₆H₄O₂)₃; NaCF₃SO₃, sodium triflate (NaTf) and Et₄NBF₄. In preferred embodiments, additives may be added to the electrolyte.

The nominal capacity of a lithium-ion-based energy storage element designed as a cylindrical round cell is preferably up to 15000 mAh. With a form factor of 21×70, the energy storage element in an embodiment as a lithium-ion cell preferably has a nominal capacity in a range from 1500 mAh to 7000 mAh, preferably in a range from 3000 to 5500 mAh. With a form factor of 18×65, the cell in an embodiment as a lithium-ion cell preferably has a nominal capacity in a range from 1000 mAh to 5000 mAh, preferably in a range from 2000 to 4000 mAh.

In the European Union, manufacturers' information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

The current collectors of the energy storage cell have the function of electrically contacting electrochemically active components contained in the respective electrode material over as large an area as possible. In particular, the ribbon-shaped metal foils consist of a metal foil or are at least metallized on the surface.

In a lithium-ion cell, suitable metals for the anode current collector include copper or nickel or other electrically conductive materials, in particular copper and nickel alloys or nickel-coated metals. In particular, materials of type EN CW-004A or EN CW-008A with a copper content of at least 99.9% can be used as copper alloys. Alloys of the type NiFe, NiCu, CuNi, NiCr and NiCrFe are particularly suitable as nickel alloys. Stainless steel can also be considered, for example type 1.4303 or 1.4404 or type SUS304.

Aluminum or other electrically conductive materials, including aluminum alloys, are particularly suitable as the metal for the cathode current collector for a lithium-ion cell.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

The energy storage cell can have a metallic housing which is customary per se for such cells. A housing for a cell in the form of a cylindrical round cell conveniently comprises a housing cup, which serves to receptable the wound electrode-separator assembly, and a lid component, which closes the opening of the housing cup. The housing cup can be a deep-drawn component, for example made of nickel-plated steel or stainless steel, with a wall thickness in a range from 0.1 mm to 2 mm. A seal is conveniently arranged between the lid component and the housing cup, which on the one hand serves to seal the cell housing, but on the other hand also has the function of electrically insulating the lid component and the housing cup from each other. The seal is mounted on the edge of the lid component, for example. To close the round cells, the opening edge of the housing cup can be bent radially inwards over the edge of the lid component enclosed by the seal (crimping process), so that the lid component including the seal is positively fixed in the opening of the housing cup.

To assemble the cells, the electrode-separator assembly is generally produced first, before the electrode-separator assembly is inserted into the cylindrical and metallic housing in a separate work step, which is then sealed.

The electrode coil itself can initially be produced on a winding machine in particular and then transported to a separate assembly line and inserted into a half-cup, which is made of nickel-plated steel or stainless steel, for example.

In other embodiments, it may be provided that the housing is produced, for example, by the multiple winding of a metal foil.

In preferred embodiments of the energy storage cell, the cell is characterized by at least one of the following additional features:
a. The anode current collector and the cathode current collector each have a first longitudinal edge and a second longitudinal edge;
b. The anode current collector has a strip-shaped main region which is loaded with a layer of the negative electrode material and a free edge strip which extends along the first longitudinal edge and which is not loaded with the electrode material;
c. The cathode current collector has a strip-shaped main region which is loaded with a layer of the positive electrode material and a free edge strip which extends along the first longitudinal edge and which is not loaded with the electrode material;
d. The negative electrode and the positive electrode are formed and/or arranged relative to one another within the electrode-separator assembly in such a way that the free edge strip of the anode current collector forms one of the terminal end faces and/or the free edge strip of the cathode current collector forms the other of the terminal end faces of the cylindrical winding.

Preferably, the aforementioned features a. to c. and preferably the aforementioned features a. to d. are realized in combination with one another.

According to the aforementioned feature d., it is preferred that the free edge strip of the anode current collector on one terminal end face and the free edge strip of the cathode current collector on the other terminal end face of the cylindrical winding form the respective end face. The particular advantage here is that the respective electrodes can be contacted via these free edge strips of the current collectors. This contact can be made, for example, via sheet metal parts or contact components that rest on one or both end faces of the winding and are connected to the longitudinal edges of the current collectors, for example by welding. This type of cell design is associated with significantly reduced internal resistance, so that large currents can be absorbed very well and heat can be better dissipated from the winding.

In preferred further developments in these embodiments of the energy storage cell, the cell is characterized by at least one of the following additional features:
a. The electrode-separator assembly, which is designed as a cylindrical winding, has an end face which is formed by a longitudinal edge of the anode current collector, in particular the free edge strip of the anode current collector, or which is formed by a longitudinal edge of the cathode current collector, in particular the free edge strip of the cathode current collector;
b. A longitudinal edge of the anode current collector, in particular the free edge strip of the anode current collector, and/or a longitudinal edge of the cathode current collector, in particular the free edge strip of the cathode current collector, enclose a gap with a spiral geometry;
c. The rolled longitudinal edge of the separator strip is arranged in the gap with a spiral geometry and thus closes the end face formed by the respective longitudinal edge of the anode current collector or the cathode current collector.

In a preferred manner, the aforementioned features a., b. and c. are realized in combination with one another.

In this case, it may be provided that the rolled longitudinal edge of the separator ribbon is only located on one end face of the winding-shaped electrode-separator assembly. In a preferred manner, a rolled longitudinal edge of a separator ribbon is located on both end faces of the winding-shaped electrode-separator assembly. This can preferably be the rolled longitudinal edges of two separator ribbons. It is also possible for the two longitudinal edges of a separator strip to be rolled on the two end faces of the winding.

In the embodiment with rolled longitudinal edges of one or more separator ribbons on both end faces of the winding-shaped electrode-separator assembly, penetration of particles is reliably prevented on both end faces of the winding, so that the risk of fine and/or short circuits due to penetrating particles is particularly reliably prevented or at least greatly minimized, especially in this embodiment.

In a preferred manner, the at least one longitudinal edge of the at least one separator ribbon is rolled over its entire length. This therefore means that the entire respective end face, at which the longitudinal edge of the separator ribbon runs in a spiral, is in principle completely closed by the rolled longitudinal edge of the separator ribbon, so that particles can no longer penetrate into the interior of the electrode-separator assembly.

In further preferred embodiments, it is preferred that the at least one longitudinal edge of the at least one separator ribbon is rolled over at least 30%, preferably at least 50%, in particular at least 70%, of its length.

When manufacturing an energy storage cell, it is particularly advantageous in this context if this closure of the end faces of the winding takes place relatively early in the manufacturing process, in particular immediately after the winding has been formed. The advantage here is that the winding is protected early on in the manufacturing process.

In preferred embodiments of the energy storage cell, the cell is characterized by at least one of the following additional features:
a. The at least one separator comprises the separator ribbon with the longitudinal edge rolled at least in a section as a first separator ribbon;
b. The at least one separator comprises a second separator ribbon which is arranged between the positive and the negative electrode and separates the electrodes from each other;
c. The second separator ribbon has a first and a second flat side, each facing one of the electrodes, and a first longitudinal edge and a second longitudinal edge; and
d. The second separator strip also has a coating of an inorganic non-conductor on one of its flat sides, at least in an area;
e. At least one of the longitudinal edges of the second separator ribbon is rolled in at least a section.

Preferably, the aforementioned features a. to e. are realized in combination with each other.

This embodiment of the energy storage cell is thus characterized in particular by the fact that at least two separator ribbons are provided in the electrode-separator assembly, which separate the positive electrode and the negative electrode from each other. The sequence within the winding-shaped electrode-separator assembly can be formed in particular as follows: separator ribbon/positive electrode/separator ribbon/negative electrode or, alternatively, separator ribbon/negative electrode/separator ribbon/positive electrode.

Both the first separator ribbon and the second separator ribbon are characterized by the fact that a coating with an inorganic non-conductor is provided at least in an area on only one of their flat sides. Preferably, at least one or both longitudinal edges of the respective separator ribbon are coated on one side, whereby a full-surface coating of the separator ribbons can also be provided on one side in each case. The rolled longitudinal edges of the first and second separator strips can be located on one or both end faces of the winding-shaped electrode-separator assembly.

In preferred embodiments of the energy storage cell with a winding comprising at least two separator ribbons, the cell is characterized by at least one of the additional features:
a. The cathode current collector and the anode current collector each have a first longitudinal edge and a second longitudinal edge;
b. The cathode current collector has a strip-shaped main region which is loaded with a layer of the positive electrode material and a free edge strip which extends along the first longitudinal edge and which is not loaded with the electrode material;
c. The anode current collector has a strip-shaped main region which is loaded with a layer of the negative electrode material and a free edge strip which extends along the first longitudinal edge and which is not loaded with the electrode material;
d. The negative electrode and the positive electrode are formed and/or arranged relative to one another within the electrode-separator assembly in such a way that the free edge strip of the anode current collector protrudes from one of the terminal end faces and the free edge strip of the cathode current collector protrudes from the other of the terminal end faces of the electrode-separator assembly;
e. The free edge strip of the cathode current collector encloses a first gap with a spiral geometry;
f. The rolled longitudinal edge of the first separator strip is arranged in the first gap with a spiral geometry and thus closes the end face of the electrode-separator assembly formed by the edge strip of the cathode current collector;
g. The free edge strip of the anode current collector encloses a second gap with a spiral geometry;
h. The rolled longitudinal edge of the second separator strip is arranged in the second gap with a spiral geometry and thus closes the end face of the electrode-separator assembly formed by the edge strip of the anode current collector.

In a preferred manner, the aforementioned features a. to h. are realized in combination with each other.

In this embodiment, the edge strip of the anode current collector, which is free of electrode material, protrudes from one end face of the winding-shaped electrode-separator assembly and the edge strip of the anode current collector, which is free of electrode material, protrudes from the opposite end face, meaning the respective end faces are formed by this free edge strip. The free edge strips of the current collectors are thus in principle available for contacting the respective electrodes over their entire length. The two separator strips are arranged in the electrode-separator assembly in such a way that the rolled longitudinal edge of one separator strip closes the end face on one side of the winding and the rolled longitudinal edge of the second or other separator strip closes the opposite end face of the electrode-separator assembly.

With regard to the coating of the separator ribbon or separator ribbons with the inorganic non-conductor, the energy storage cell is characterized in preferred embodiments by at least one of the following additional features:
a. The at least one separator ribbon has the coating of the inorganic non-conductor only on one of its flat sides;
b. The at least one separator ribbon has the coating of the inorganic non-conductor only along one of its longitudinal edges;
c. The at least one separator ribbon has only one flat side, which is fully coated with the inorganic non-conductor.

In preferred embodiments, either the aforementioned features a. and b. or the aforementioned features a. and c. are realized in combination with each other.

The aforementioned feature a., according to which only one of the flat sides of the separator ribbon is coated with the inorganic non-conductor, is particularly advantageous. Due to this coating on one side, the rolling of the longitudinal edge of the separator ribbon is achieved in a particularly controlled and reproducible manner solely by thermal treatment of the winding or the respective end face of the winding when the winding-shaped electrode-separator assembly is provided.

A coating exclusively in the region of one of the longitudinal edges of the separator ribbon according to the aforementioned feature b. is in principle sufficient for rolling the respective longitudinal edge in the course of manufacturing the cell. However, a full-surface coating of the respective side of the separator ribbon according to the aforementioned feature c. may be preferred. This offers advantages for the coating process, since the coating can be carried out with less effort.

The coating of the separator ribbon or ribbons with the inorganic non-conductor can, if necessary, also be provided only in a partial section, with regard to the length of the separator ribbon. However, a coating over the entire length of the separator ribbon is preferred, whereby if necessary only the longitudinal edge region of the separator ribbon is coated, but then over the entire length of the separator ribbon.

In further preferred embodiments of the energy storage cell, the cell is characterized by at least one of the following additional features:
a. The coating of the inorganic non-conductor is located on the flat side of the separator strip facing the positive electrode;
b. The coating of the inorganic non-conductor is located on the flat side of the separator strip facing the negative electrode;
c. The longitudinal edge of the separator ribbon is rolled in such a way that the coating of the inorganic non-conductor faces outwards.

If, for example, two separator ribbons are provided in the electrode-separator assembly, it may be provided that the one-sided coating of one separator ribbon faces the positive electrode and the one-sided coating of the other separator ribbon faces the negative electrode or vice versa. It is also possible for the one-sided coating of two separator ribbons to face the positive electrode or the negative electrode. It is preferable if the coating on one side of the separator ribbons faces the positive electrode in each case.

Traditionally, ceramic coatings are used on separators to stabilize them against thermal stresses as a whole. In the present case, however, the coating made of the inorganic non-conductor has the function of specifically deforming a subregion of the separator under thermal stress. The coating made of the inorganic non-conductor only stabilizes the side to which it is applied. The other side, on the other hand, contracts slightly at elevated temperatures and causes the separator edge to roll.

With regard to the materials for the coating of the separator ribbon, the energy storage cell is preferably characterized by the following additional feature:
a. The coating of the inorganic non-conductor comprises a material or comprises a combination of materials selected from the following group: ceramic material, glass-ceramic material, glass, lithium ion conductive ceramic material, oxide material, metal oxide material, aluminum oxide, titanium oxide, titanium nitride, titanium aluminum nitride, silicon oxide, silicon dioxide, titanium carbonitride.

It is possible that one or, if necessary, two or more of these materials are used for the coating.

Ceramic materials are preferred. Ceramic materials are to be understood in particular as carbides, nitrides, oxides, silicides or mixtures and derivatives of these compounds.

In particular, glass-ceramic materials can be used which comprise, for example, crystalline particles embedded in an amorphous glass phase. The term glass basically refers to any inorganic glass which is thermally stable and which is advantageously chemically stable with respect to the electrolyte present in the cell.

Aluminum oxide, titanium oxide and silicon dioxide, for example, are particularly suitable as coating materials for the separator strip(s), as these materials are characterized by their particularly suitable thermoplastic properties.

It is preferred that the coating is formed from the inorganic non-conductor by means of deposition from the gas phase, in particular by means of a PVD method (PVD =Physical Vapor Deposition), on the at least one separator ribbon. SALD (Spatial Atomic Layer Deposition), for example, is particularly suitable.

In alternative preferred embodiments, the coating of the inorganic non-conductor can also be formed by a coating composition, which in addition to the inorganic non-conductor further comprises a binder that fixes the inorganic non-conductor to the at least one separator ribbon. Plastic-based binders, for example from the group comprising PVA (polyvinyl alcohol), PVDF (polyvinylidene fluoride) and SBR (styrene-butadiene rubber), are preferably suitable as binders.

In preferred embodiments of the energy storage cell, the cell is characterized by the following additional feature:
a. The energy storage cell comprises at least one contact component that rests flat on one end face of the electrode-separator assembly, which is formed as a cylindrical winding.

In particular, the contact component can rest on the free edge strip of the anode current collector forming the respective end face or the free edge strip of the cathode current collector forming the respective end face of the winding and be used to make contact with the respective electrode.

Such a contact component, for example a flat sheet metal part in the form of a disk or similar, can be provided on one or possibly both end faces of the winding. In particular, both the positive electrode and the negative electrode can be in direct or indirect contact with the housing using such a contact component. However, it is also possible that contacting by means of such a contact component is only used on one side of the winding or only for one of the electrodes and the other electrode is contacted with the housing, for example via a metallic contact strip (internal arrester) or similar.

In preferred embodiments, such internal arresters are dispensed with and the electrodes are contacted via the longitudinal edges of the current collector strips on the end faces of the winding via the aforementioned contact components. Accordingly, the end faces of the winding can be electrically connected via the contact components, which are connected to the housing with corresponding arresters, or with the contact components, which are connected directly to the housing.

According to a second aspect, a method is provided for manufacturing an energy storage cell. The method comprises the following steps:
a. Providing at least one ribbon-shaped positive electrode and at least one ribbon-shaped negative electrode, wherein the ribbon-shaped positive electrode comprises a ribbon-shaped cathode current collector with a coating of a positive electrode material and the ribbon-shaped negative electrode comprises a ribbon-shaped anode current collector with a coating of a negative electrode material;
b. Providing at least one separator ribbon with a first flat side and with a second flat side, wherein the separator ribbon has a coating of an inorganic non-conductor on one of its flat sides, at least in an area;
c. Formation of an electrode-separator assembly formed as a cylindrical winding from the electrode strips, wherein the at least one separator strip is arranged between the positive and the negative electrode so that it separates the electrodes from one another;
d. Insertion of the electrode-separator assembly into a cylindrical housing, whereby the electrode-separator assembly is arranged axially in the housing.

According to at least one embodiment, this method is characterized in that:
e. the electrode-separator assembly is subjected to a heat treatment such that at least one longitudinal edge of the at least one separator strip is rolled at least in a section.

A key point of the method is the aforementioned feature e., according to which the winding-shaped electrode-separator assembly is subjected to a heat treatment so that at least one longitudinal edge of the at least one separator ribbon is rolled at least in a section.

This rolling of a longitudinal edge of a separator ribbon can be provided on one or both end faces of the electrode-separator assembly, so that either one or both end faces of the winding-shaped electrode-separator assembly are subjected to heat treatment. It is important for the longitudinal edge of the separator ribbon to be coated with an inorganic non-conductor. Ceramic materials are preferred here. It is particularly advantageous if this coating is only on one side of the separator ribbon, i.e. it is a one-sided coating. This coating is preferably located at least in the region of the respective longitudinal edge of the separator ribbon, but can also cover the entire surface of a flat side of the separator ribbon. This coating, in particular this one-sided coating of the separator ribbon, achieves a targeted and controlled rolling of the respective longitudinal edge by means of the heat treatment. The one-sided coating means that the longitudinal edge of the separator ribbon, which has a spiral geometry, preferably rolls in completely and regularly in one direction over its entire length, so that all rolled side edge sections have the same orientation in a sectional view of the winding.

The inorganic material for the coating of the separator ribbon is a thermoplastic material in particular. When heated, the material undergoes thermal deformation, which causes the separator ribbon to roll due to the prevailing tensile forces and thus close the open regions on the end face(s) of the electrode-separator assembly.

The separator ribbon or ribbons themselves are preferably temperature-stable. Only the coating of the separator ribbon is thermoplastic.

The separator ribbon itself is an electrically insulating flat structure, for example a film, a fabric or a fleece, for example made of plastic. This plastic can, for example, have a thickness in a range from 5 μm to 50 μm, preferably in a range from 10 μm to 30 μm, depending on the dimensions of the energy storage cell. If the separator ribbon is formed by a plastic film, this film can be made of polyolefin or polyether ketone, for example.

The thickness of the coating of the separator ribbon with the inorganic non-conductor is, for example, in a range from 0.5 μm to 5 μm.

Preferably, the anode current collector and/or the cathode current collector are each a ribbon-shaped metal foil with a thickness in a range from 4 μm to 30 μm.

The anode current collector ribbon, the cathode current collector ribbon and the separator ribbon or separator ribbons of the cell preferably have the following dimensions:
A length in a range from 0.5 m to 25 m;
A width in a range from 40 mm to 145 mm.

When manufacturing the winding-shaped electrode-separator assembly, it is preferable for the separator ribbon(s) to have the same width as the electrode ribbons or the current collector ribbons before heat treatment. Due to the end face heat treatment of the electrode-separator assembly after the winding, the longitudinal edge or edges of the separator ribbon or ribbons roll in such a way that the rolled section of the separator ribbon or ribbons is located between the outer end of the respective current collectors and the main region of the electrode ribbons coated with electrode material.

The coating of the separator ribbon is preferably carried out before the actual winding of the electrode-separator assembly. This winding of the electrode ribbons and of the separator ribbon(s) itself is preferably carried out in a manner known per se on a winding machine, in which the corresponding electrode ribbons and separator ribbons are fed. In other embodiments, an assembly of the electrode ribbons and the separator ribbon(s) can first be produced before the assembly is fed to the winding machine.

After or during the insertion of the electrode-separator assembly into a cylindrical housing, the electrodes are contacted with the housing in a manner known per se, for example by means of one or two of the contact components already explained, which can be attached to one or, if necessary, both end faces of the cylindrical winding. The introduction of electrolyte and the closing of the housing can also be carried out in a manner known per se.

The housing may be a conventional metallic housing, which in principle comprises a housing cup and a lid. In other embodiments, the housing can also be formed in other ways, for example by a winding of metal foils or other.

In preferred embodiments of the method, at least one of the following additional features is provided:
a. A temperature in a range from 200° C. to 700° C. is used for the heat treatment;
b. The heat treatment is carried out using hot air and/or infrared radiation and/or a laser beam.

Depending on the material and type of coating and depending on the material and thickness of the separator ribbon(s), the heat treatment can be adapted, particularly with regard to the temperature and duration of the heat treatment.

In terms of process technology, hot air blowers, infrared lamps or laser beams can be used, for example, to heat treat the end faces of the electrode-separator assembly. This treatment of the winding-shaped electrode-separator assembly is preferably carried out immediately after the winding has been formed, for example while it is still on the winding machine. This has the advantage that the winding is protected from any penetrating particles at an early stage.

In a preferred embodiment of the method, the method is characterized by at least one of the following additional features:
a. The cathode current collector of the positive electrode and/or the anode current collector of the negative electrode have a free edge strip along one of their longitudinal edges which is not coated with the electrode material;
b. After the electrode-separator assembly has been formed, the free edge strip of the cathode current collector and/or the free edge strip of the anode current collector forms one of the end faces of the cylindrical winding;
c. For electrical contacting of the positive electrode and/or the negative electrode, a contact component is placed flat on the free edge strip of the cathode current collector and/or the anode current collector and fixed there;
d. Fixing is carried out by welding, in particular by laser welding.

Preferably, the aforementioned features a. to d. are realized in combination with each other.

As already explained above in connection with the features of the energy storage cell, such a contact component can be provided on one or possibly both end faces of the winding-shaped electrode-separator assembly. The contact component(s) can then be connected to the housing components via an additional arrester or, if necessary, directly.

Fixing the contact component(s) to the end face(s) of the winding is preferably carried out in a range from the winding machine before the electrode-separator assembly is transported to a separate assembly line for assembling the housing.

Fixing the contact component by means of welding and in particular laser welding is preferred. Using such a contacting method, the free edge areas of the current collectors, which form the end faces in the winding in a spiral shape, can be contacted very precisely and locally limited with the respective contact component by creating defined material connections. This makes it possible to maintain a very small distance between point contacting areas over the entire spiral electrode length in the sense of so-called multi-pin contacting and thus achieve quasi-continuous contacting. In principle, continuous contacting is even possible over the entire spiral length of the electrode ribbons.

In a preferred manner, at least one of the following additional features is provided in the method:
a. Heat treatment is carried out by transferring heat via the contact component;
b. The heat treatment takes place in the course of contacting the at least one electrode.

Preferably, the aforementioned features a. and b. are realized in combination with each other.

Heat treatment according to the concept according to the present disclosure by coupling heat via the contact component(s) is particularly advantageous, as such heat coupling can take place very evenly. Only the contact component, which for example has the shape of a plate and is a metallic component, needs to be heated. Due to the uniform coupling of heat into the end face of the winding, the longitudinal edge(s) is/are rolled in a particularly regular and reproducible manner. It is particularly advantageous if the contact component completely covers the respective end face of the winding.

With particular advantage, the heat treatment can be carried out in the course of contacting the at least one electrode ribbon. In this embodiment, both the electrical connection of the respective electrode and the sealing of the respective end face are achieved in a single work step. This is based on the fact that when the contact component is welded onto the end face, which is preferably used to make contact with the electrode, sufficient heat is generally generated to achieve the desired effect of rolling the spiral longitudinal edge of the separator ribbon. In this embodiment, it is therefore not absolutely necessary for the heat treatment for the rolling to be carried out in a separate step.

With regard to further features of the method, reference is also made to the above description of the features of the energy storage cell.

Finally, the present disclosure provides an energy storage cell which can be produced according to the method described. In this energy storage cell, the winding-shaped electrode-separator assembly is characterized in that one or both end face regions of the winding are rolled by thermally deforming the respective longitudinal edges of the separator ribbon or ribbons. The end faces closed by this or the end face of the winding-shaped electrode-separator assembly closed by this protects the electrode-separator assembly from penetrating particles, which could possibly cause a fine short circuit or short circuit of the cell. With regard to further features of this energy storage cell, reference is also made to the above description.

Further features and advantages are apparent from the following description of preferred examples in conjunction with the drawings. The individual features can be realized separately or in combination with each other.

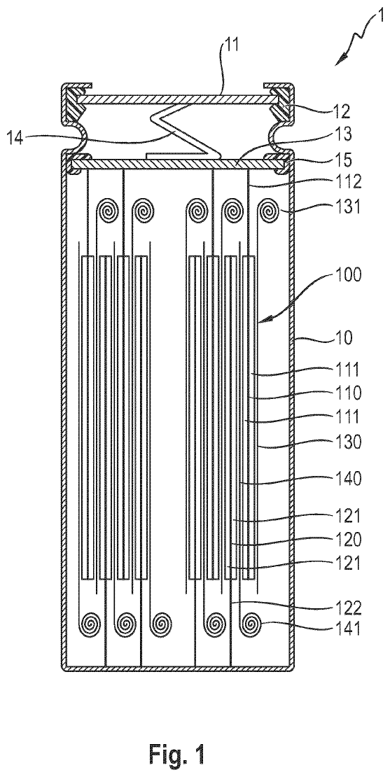

FIG. 1 shows a schematic longitudinal section through a lithium-ion energy storage cell 1 in the form of a cylindrical round cell. The energy storage cell 1 comprises a metallic housing, which is formed from a housing cup 10 and a housing lid 11. A seal 12 is provided between the housing cup 10 and the lid 11, for example in the form of a circumferential sealing ring.

In the central interior space of the energy storage cell 1 there is an electrode-separator assembly 100, which is formed as a cylindrical winding with a terminal end face in the upper region and in the lower region of the cell. The winding-shaped electrode-separator assembly 100 is formed of a ribbon-shaped positive electrode and a ribbon-shaped negative electrode, the electrodes being separated from each other by separator ribbons 130 and 140. The positive electrode comprises a ribbon-shaped current collector 110 coated on both sides by a positive electrode material 111. The negative electrode comprises an anode current collector 120, which is coated on both sides by a negative electrode material 121.

In this example embodiment, the electrodes are formed such that the respective current collector 110, 120 each has a strip-shaped main region with a layer of the respective electrode material 111, 121 on both sides. In addition, the cathode current collector 110 has a free edge strip 112 which extends along a longitudinal edge of the cathode current collector and which is not coated with the electrode material. The anode current collector 120 also has a free edge strip 122 along one of its longitudinal edges, which is not coated with electrode material. In this embodiment, the free edge strip 112 of the cathode current collector is located in the region of the upper end face of the winding-shaped electrode-separator assembly 100 and the free edge strip 122 of the anode current collector is located in the region of the opposite end face of the electrode-separator assembly 100. In this example embodiment, the electrical contacting of the electrodes takes place via these free edge strips 112 and 122 of the current collectors.

The free edge strip 122 of the anode current collector is electrically connected to the bottom of the housing cup 10. The free edge strip 112 of the cathode current collector is electrically connected to a contact component 13, whereby this contact component 13, for example in the form of a metallic disk or plate, rests on the corresponding end face of the electrode-separator assembly 100. The contact component 13 is connected to the lid 11 of the housing via an arrester 14. Furthermore, electrical insulation 15 is provided between the contact component 13 and the surrounding housing cup 10.

The winding-shaped electrode-separator assembly 100 is designed such that the separator ribbons 130, 140, which insulate the electrodes from each other, are located between the positive electrode ribbon and the negative electrode ribbon.

In various embodiments of the present disclosure, the separator ribbons 130 and 140 protruding at the end faces of the cylindrical electrode-separator assembly 100 are rolled in these longitudinal regions 131 and 141 and form a regular structure. This deformation of the longitudinal edges of the separator ribbons 130, 140 causes extensive or complete closure of the open regions of the winding-shaped electrode-separator assembly 100 at the respective end face of the electrode-separator assembly 100, what is schematically indicated here. This deformation of the longitudinal regions of the separator ribbons 130, 140 ensures that no electrically conductive particles can penetrate into the interior of the electrode-separator assembly 100. Such particles could possibly lead to a fine short circuit or short circuit by bridging the electrode polarities. This is avoided by the measure according to the present disclosure.

The structure of the longitudinal edges 131, 140 of the separator ribbons is achieved in particular by thermally deforming these regions of the separator ribbons. The targeted and reproducible deformation of the longitudinal edges of the separator ribbons is achieved in particular by coating one side of the separator ribbons with an inorganic non-conductor, in particular with a thermoplastic ceramic material. For the sake of clarity, this one-sided coating is not shown in FIG. 1.

During thermal treatment to create these structures, the coating on the separator ribbons is thermally deformed and shrinks, causing the longitudinal edges of the separator ribbons to roll up.

The preferably single-sided coating of the separator ribbons can be limited to the longitudinal regions of the separator ribbons. In preferred embodiments, the separator ribbons are coated with an inorganic non-conductor over their entire surface on one side in each case.

In the example shown in FIG. 1, the rolled longitudinal edge 131 of the separator ribbon 130 in the region of the upper end face and the rolled longitudinal edge 141 of the other separator ribbon 140 on the opposite end face of the electrode-separator assembly protrude beyond the main regions of the electrode ribbons coated with electrode material. In this way, a closure of the electrode-separator assembly 100 on both end faces of the resulting winding is achieved by rolling up the respective protruding longitudinal edges 131, 141.

The longitudinal edges of the current collectors 112, 122, which are available for contacting the electrodes, protrude between the rolled-up longitudinal edges 131, 141 of the separator ribbons in the end faces of the winding.

During the manufacturing process of the energy storage cell 1, the end faces of the winding are advantageously subjected to a thermal treatment (heat treatment) more or less immediately after the production of the wound electrode-separator assembly 100, so that the longitudinal edges 131, 141 of the separator ribbons roll up accordingly and close the winding and thus protect it.

It is preferred if the heat treatment is carried out by coupling heat via the contact component 13 by heating this disc-shaped metallic element and thus transferring the heat evenly to the end face of the winding.

In a preferred manner, this is linked to the contacting process of the electrodes, whereby the current collectors are electrically connected to the contact component 13 or, if applicable, to the bottom of the housing 10 via laser welding. In general, the heat generated during laser welding is sufficient for rolling the longitudinal edges of the separator ribbons.

Irrespective of the coating of the separator ribbons, it may be provided that the current collectors are also provided with a coating that elevates the stability of the current collectors during the manufacturing process and in particular during the welding of corresponding contact components.

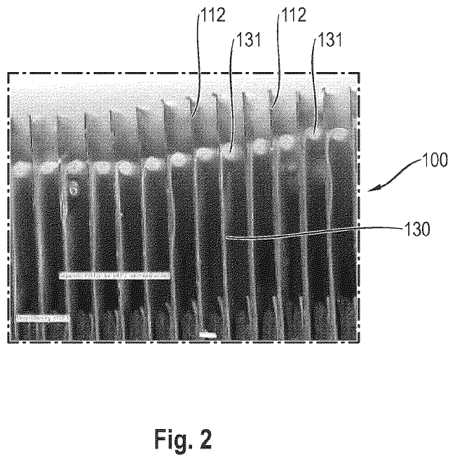

FIG. 2 shows an X-ray longitudinal sectional view of a section of an end face region of a winding-shaped electrode-separator assembly 100 of an energy storage cell. The regularly rolled longitudinal edges 131 of the separator ribbon 130 can be clearly seen. By coating one side of the separator ribbon 130, a uniform and defined deformation of the spiral-shaped longitudinal edge 131 was achieved, which closes the open regions of the electrode-separator assembly 100 in this end face region.

In addition, the protruding free edge of the current collector 112, for example the cathode current collector, can be seen in this sectional view, which protrudes above the rolled regions 131 and which is available for electrical contacting of the electrode.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An energy storage cell, comprising:
an electrode-separator assembly designed as a cylindrical winding with two terminal end faces, the electrode-separator assembly comprising:
at least one ribbon-shaped positive electrode comprising a ribbon-shaped cathode current collector with a coating of positive electrode material,
at least one ribbon-shaped negative electrode comprising a ribbon-shaped anode current collector with a coating of a negative electrode material, and
at least one separator comprising at least one separator ribbon arranged between at least one positive electrode and at least one negative electrode so as to separate the electrodes from each other, the separator ribbon comprising a first and a second side, each facing one of the electrodes, and a first longitudinal edge and a second longitudinal edge,
wherein the separator ribbon has a coating comprising an inorganic non-conductor on the first side and/or the second side, at least in an area, and
wherein the first longitudinal edge and/or the second longitudinal edge of the separator ribbon is rolled in at least a section.

2. The energy storage cell of claim 1, wherein at least one of:
the anode current collector and the cathode current collector each have a first longitudinal edge and a second longitudinal edge;
the anode current collector has a strip-shaped main region which is loaded with a layer of the negative electrode material and a free edge strip which extends along the first longitudinal edge and which is not loaded with the negative electrode material;
the cathode current collector has a strip-shaped main region which is loaded with a layer of the positive electrode material and a free edge strip which extends along the first longitudinal edge and which is not loaded with the positive electrode material;
the negative electrode and the positive electrode are formed and/or arranged within the electrode-separator assembly relative to one another in such a way that the free edge strip of the anode current collector forms one of the terminal end faces and/or the free edge strip of the cathode current collector forms the other of the terminal end faces of the cylindrical winding.

3. The energy storage cell of claim 2, wherein at least one of:
the electrode-separator assembly, has an end face which is formed by a longitudinal edge of the anode current collector or which is formed by a longitudinal edge of the cathode current collector;
a longitudinal edge of the anode current collector and/or a longitudinal edge of the cathode current collector enclose a gap with a spiral geometry;
the rolled longitudinal edge of the separator ribbon is arranged in the gap with a spiral geometry and thus closes the end face formed by the respective longitudinal edge of the anode current collector or the cathode current collector.

4. The energy storage cell according to claim 1, wherein the longitudinal edge of the separator ribbon is rolled over its entire length.

5. The energy storage cell according to claim 1, wherein at least one of:
the at least one separator comprises the separator ribbon with the longitudinal edge rolled in at least in a section as a first separator ribbon;
the at least one separator comprises a second separator ribbon arranged between the positive electrode and the negative electrode and separating the electrodes from each other;
the second separator ribbon has a first and a second flat side, each facing one of the electrodes, as well as a first longitudinal edge and a second longitudinal edge;
the second separator ribbon has a coating of an inorganic non-conductor on the first side or the second side, at least in an area;
at least one of the longitudinal edges of the second separator ribbon is rolled in at least a section.

6. The energy storage cell of claim 5, wherein at least one of:
the cathode current collector and the anode current collector each have a first longitudinal edge and a second longitudinal edge;
the cathode current collector has a strip-shaped main region which is loaded with a layer of the positive electrode material and a free edge strip which extends along the first longitudinal edge and which is not loaded with the positive electrode material;
the anode current collector has a strip-shaped main region which is loaded with a layer of the negative electrode material and a free edge strip which extends along the first longitudinal edge and which is not loaded with the negative electrode material;
the negative electrode and the positive electrode are formed and/or arranged within the electrode-separator assembly relative to one another in such a way that the free edge strip of the anode current collector protrudes from one of the terminal end faces and the free edge strip of the cathode current collector protrudes from the other of the terminal end faces of the electrode-separator assembly:
the free edge strip of the cathode current collector encloses a first gap with a spiral geometry;
the rolled longitudinal edge of the first separator ribbon is arranged in the first gap with a spiral geometry and thus closes the end face of the electrode-separator assembly formed by the edge strip of the cathode current collector;
the free edge strip of the anode current collector includes a second gap with a spiral geometry;
the rolled longitudinal edge of the second separator ribbon is arranged in the second gap with a spiral geometry and thus closes the end face of the electrode-separator assembly formed by the edge strip of the anode current collector.

7. The energy storage cell according to claim 1, wherein at least one of:
the at least one separator ribbon has the coating of the inorganic non-conductor only on one side;
the at least one separator ribbon has the coating of the inorganic non-conductor only along one of its longitudinal edges;
the at least one separator ribbon has only one flat side which is coated over its entire surface with the inorganic non-conductor.

8. The energy storage cell according to claim 1, wherein at least one of:
the coating of the inorganic non-conductor is located on the flat side of the separator ribbon facing the positive electrode;
the coating of the inorganic non-conductor is located on the flat side of the separator ribbon facing the negative electrode;
the longitudinal edge of the separator ribbon is rolled in such a way that the coating of the inorganic non-conductor faces outwards.

9. The energy storage cell according to claim 1, wherein the coating of the inorganic non-conductor comprises a material or comprises a combination of materials selected from the following group: ceramic material, glass-ceramic material, glass, lithium ion conductive ceramic material, oxide material, metal oxide material, aluminum oxide, titanium oxide, titanium nitride, titanium aluminum nitride, silicon oxide, silicon dioxide, titanium carbonitride.

10. The energy storage cell according to claim 1, further comprising at least one contact component that rests flat on one end face of the electrode-separator assembly formed as a cylindrical winding.

11. A method of manufacturing an energy storage cell according to claim 1, the method comprising:
providing at least one ribbon-shaped positive electrode and at least one ribbon-shaped negative electrode, wherein the ribbon-shaped positive electrode comprises a ribbon-shaped cathode current collector with a coating of a positive electrode material and the ribbon-shaped negative electrode comprises a ribbon-shaped anode current collector with a coating of a negative electrode material;
providing at least one separator ribbon with a first flat side and with a second flat side, wherein the separator ribbon has a coating of an inorganic non-conductor on one of its flat sides, at least in an area;
forming an electrode-separator assembly as a cylindrical winding from the electrode ribbons, wherein the at least one separator ribbon is arranged between the positive and the negative electrode to separate the electrodes from one another;
inserting the electrode-separator assembly into a cylindrical housing, wherein the electrode-separator assembly is arranged axially in the housing; and
subjecting the electrode-separator assembly to a heat treatment such that at least one longitudinal edge of the at least one separator ribbon rolls up at least in a section.

12. The method of claim 11, wherein at least one of:
temperature in a range from 200° C. to 700° C. is used for the heat treatment;
the heat treatment is carried out using hot air and/or infrared radiation and/or a laser beam.

13. The method according to claim 11, wherein at least one of:
the cathode current collector of the positive electrode and/or the anode current collector of the negative electrode has a respective free edge strip along a longitudinal edge not coated with electrode material;
after forming the electrode-separator assembly, the respective free edge strip forms one of the end faces of the electrode-separator assembly;
placing a contact component flat on the respective free edge strip and fixing it there for electrical contacting;
the fixing is carried out by welding.

14. The method according to claim 11, wherein at least one of:
heat treatment is carried out by transferring heat via the contact component;
the heat treatment takes place in the course of the contacting of the at least one electrode.

15. An energy storage cell produced by a method according to claim 10.

16. The energy storage cell according to claim 1, wherein the coating comprising the inorganic non-conductor further comprises a binder.
